(19) United States
(12) Patent Application Publication
(10) Pub. No.: US 2017/0229970 A1
(43) Pub. Date: Aug. 10, 2017

(54) SWITCH-MODE POWER SUPPLY

(71) Applicant: PHILIPS LIGHTING HOLDING B.V., EINDHOVEN (NL)

(72) Inventors: GUY LOUIS PAUL DE BONDT, HERENTALS (BE); CHRISTIAN HATTRUP, WURSELEN (DE); GEORG SAUERLAENDER, AACHEN (DE)

(73) Assignee: PHILIPS LIGHTING HOLDING B.V., EINDHOVNE (NL)

(21) Appl. No.: 15/501,876

(22) PCT Filed: Jul. 29, 2015
(86) PCT No.: PCT/EP2015/067357

§ 371 Date: Feb. 6, 2017

(30) Foreign Application Priority Data
Aug. 7, 2014 (EP) 14180185.2

(51) Int. Cl. H02M 3/335; H02M 1/44; H02M 1/14; H02M 1/08

(52) U.S. Cl. CPC H02M 3/33507; H02M 1/08; H02M 1/44; H02M 1/14; H02M 2001/0009

(57) ABSTRACT

A switch-mode power supply device (1) is disclosed. The switch-mode power supply device (1) has a main circuit (6) configured to receive a DC input voltage and to provide a DC output voltage. The main circuit (6) comprises: an inductor element (12) generating the DC output voltage, a switching element (9) connected to the inductor element (12), and a controller (7) configured to switch the switching element (9) between a conducting state and a non-conducting state, wherein the switching element (9) is configured to feed a pulsed direct current to a ground potential (10). The switch-mode power supply (1) also has an auxiliary circuit (16) configured to provide an auxiliary voltage. The auxiliary circuit (16) comprises an auxiliary inductor (18) connected to receive the pulsed direct current and magnetically isolated from the inductor element (12).

### FIELD OF THE INVENTION

The present disclosure relates to a switch-mode power supply device having an auxiliary circuit for supplying an auxiliary output voltage.

### BACKGROUND OF THE INVENTION

Switch-mode power supplies are electronic circuits converting the voltage and current characteristics of an electrical power source by means of a switch, such as a transistor. Their small size and high energy efficiency make them suitable for a wide variety of applications. For example, consumer electronics, such as mobile phone chargers and laptop power supplies, usually include a switch-mode power supply for converting an alternating current of a mains electricity supply to a direct current required by the load.

In addition to the converted voltage, switch-mode power supplies are often configured to generate a low auxiliary voltage for driving the switch or some other component. An example of how to generate a supply voltage for an integrated circuit used to control a switching voltage regulator system is disclosed in US 2011/0157919 A1. It is desirable that this voltage generation be energy efficient and inexpensive to implement.

### SUMMARY OF THE INVENTION

The general object of the present disclosure is to provide an improved or alternative switch-mode power supply device. Specific objectives include providing an inexpensive and energy efficient auxiliary circuit which provides an auxiliary voltage for a component of the switch-mode power supply device or a separate circuit such as a controller for a driver for a light-emitting diode.

The invention is defined by the independent claim. Embodiments are set forth in the dependent claims, the description and the drawings.

According to a first aspect, there is provided a switch-mode power supply device comprising a main circuit, which is configured to receive a DC input voltage and to provide a DC output voltage, and an auxiliary circuit, which is configured to provide an auxiliary voltage. The main circuit comprises: an inductor element for providing the DC output voltage, a switching element connected to the inductor element, and a controller configured to switch the switching element between a conducting state and a non-conducting state. The switching element is configured to feed a pulsed direct current to a ground potential. The auxiliary circuit comprises an auxiliary inductor connected to receive the pulsed direct current and magnetically isolated from the inductor element. Hence, the auxiliary inductor is not magnetically coupled to the inductor element.

By a “pulsed direct current” is meant a direct current having a varying amplitude. The abbreviations “AC” and “DC” stand for “alternating current” and “direct current,” respectively. The auxiliary voltage is usually a DC voltage having a substantially constant amplitude. The DC input voltage is typically a rectified and buffered AC voltage.

Since the primary and auxiliary inductors are magnetically isolated, the device described above may be implemented using an inexpensive primary inductor, such as a drum core inductor, and a small auxiliary inductor, for example a surface mount device inductor. The auxiliary circuit may be simple and energy efficient.

According to one embodiment of the device, the main and auxiliary circuits are connected to a common ground. The auxiliary inductor may for example be connected to the ground potential and to a negative polarity of the DC input voltage. Connecting the main and auxiliary circuits to a common ground is advantageous for some applications since the use of a level shifter may otherwise be necessary.

According to an advantageous embodiment of the device, the auxiliary circuit comprises: a capacitor connected to the ground potential and a diode connected to the auxiliary inductor and the capacitor, wherein the auxiliary voltage is a voltage across the capacitor. The diode may be an inexpensive low-voltage diode. In order to limit the auxiliary voltage, a Zener diode may be connected in parallel with the capacitor. To reduce oscillations in the auxiliary circuit, a damping resistor may be connected in parallel with the auxiliary inductor.

According to one embodiment of the device, the inductor element is an inductor. The inductor element may thus comprise a single coil or winding. In an alternative embodiment, the inductor element is a transformer having two magnetically coupled coils.

According to one embodiment of the device, a start-up resistor is connected to the controller and a positive polarity of the DC input voltage. This may improve the start-up characteristics of the device.

According to one embodiment of the device, the auxiliary voltage is connected to the main circuit. Alternatively, the auxiliary voltage is connected to a load outside the main and auxiliary circuits.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention. Like reference numerals refer to like elements throughout.

FIG. 1 illustrates a schematic circuit diagram of an embodiment of a switch-mode power supply device.

FIG. 2 illustrates a schematic circuit diagram of an embodiment of a switch-mode power supply device having a transformer.

FIG. 3 illustrates a schematic circuit diagram indicating the current flow in an embodiment of a switch-mode power supply device during operation.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

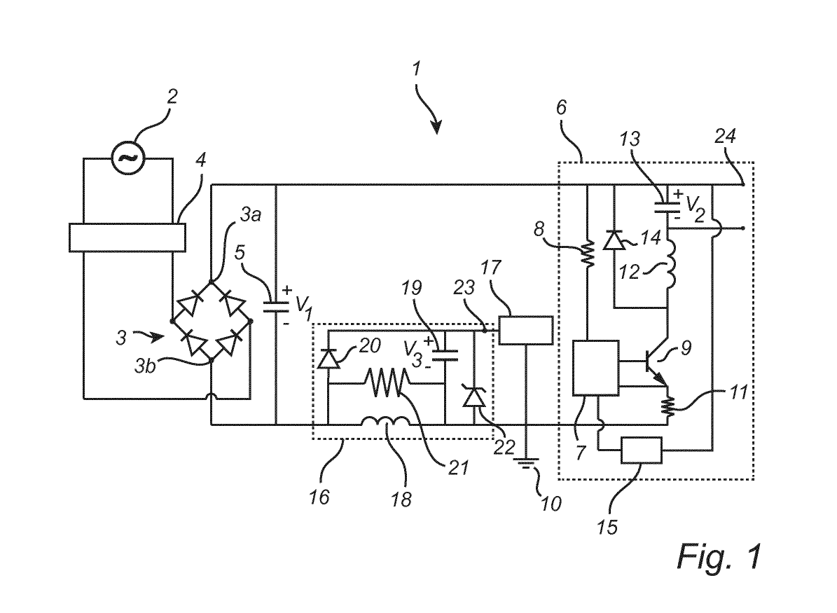

FIG. 1 illustrates a schematic circuit diagram of a switch-mode power supply device 1 connected to a power source 2, which is an AC power source that provides the switch mode power supply device 1 with an AC input voltage. As an example, the power source 2 is a mains electricity supply providing an AC input voltage having an amplitude between 100 V and 240 V and a frequency of 50 Hz or 60 Hz. The power source 2 is connected to a rectifier 3, typically via a filter 4, such as an electromagnetic interference filter. The filter 4 helps reduce noise from the power source 2, thereby protecting sensitive components in the switch-mode power supply device 1. The rectifier 3 is a diode bridge rectifier, and more particularly a full-wave rectification diode bridge rectifier. However, half-wave rectification is an applicable alternative. The rectifier 3 has a positive terminal 3a and a negative terminal 3b, the voltage difference between the terminals 3a, 3b being a DC input voltage V₁. The switch-mode power supply device further comprises an input capacitor 5, which is connected to the positive polarity of the DC input voltage V₁ via the positive terminal 3a and to the negative polarity of the DC input voltage V₁ via the negative terminal 3b. The capacitance of the input capacitor 5 may for example be in the range from about 1 μF to about 100 μF. The DC input voltage V₁ has a ripple, which is smoothed by means of the input capacitor 5. According to another embodiment, the switch-mode power supply device 1 is intended to be connected to a power source 2 supplying a DC input voltage, and then the rectifier 3 is excluded.

The switch-mode power supply device 1 has a main circuit 6 configured to receive the DC input voltage V₁ and to provide a DC output voltage V₂ for powering electronics, for example a lamp or a computer. The value of the output voltage V₂ depends on the intended application but is typically in the range from about 20 V to about 140 V. The main circuit 6 may thus operate as a DC-to-DC converter, such as a buck converter or a boost converter. The main circuit 6 has a controller 7, for example a pulse-width modulation controller, which is connected to the positive terminal 3a. The controller 7 is connected to the positive terminal 3a via a start-up resistor 8. Hence, the start-up resistor 8 is connected to the controller 7 and the positive polarity of the DC input voltage V₁. The resistance of the start-up resistor 8 may for example be in the range from about 100 kΩ to about 1 MΩ. According to another embodiment, the start-up resistor 8 is excluded.

The controller 7 is connected to a switching element 9, the controller 7 being configured to switch the switching element 9 between a conducting state and a non-conducting state. The switching element 9 in this embodiment is a transistor. The switching element 9 may be a bipolar transistor, such as a PNP transistor or an NPN transistor. The switching element 9 may be a field-effect transistor, such as a MOSFET. The switching element 9 may be a thyristor, a gate turn-off thyristor (GTO) or an insulated-gate bipolar transistor (IGBT), etc. The switching element 9 is configured to feed a pulsed direct current to a ground potential 10. The switching element 9 may be connected to the ground potential 10 via a sense resistor 11 for current measurement. The sense resistor 11 is connected to the emitter of the switching element 9 and typically has a resistance of greater than about 100 mΩ. The switching element 9 is connected to an inductor element 12 in the form of an inductor. More precisely, the inductor element 12 is an inductor comprising a single coil. The inductor element 12 is connected to the collector of the switching element 9. The inductance of the inductor element 12 may for example be in the range from about 200 μH to about 10 mH. The inductor element 12 provides the DC output voltage V₂ by storing energy that is transferred to an output of the main circuit 6 each switching cycle to generate the output voltage V₂.

The main circuit 6 typically includes other components as well. According to the embodiment shown in FIG. 1, the inductor element 12 is connected to the positive terminal 3a via an output capacitor 13 connected in series with the inductor element 12. The DC output voltage V₂ is the voltage across the output capacitor 13. The main circuit 6 is provided with output terminals 24 for connecting an external load to the output voltage V₂. A blocking diode 14, which prevents the output capacitor 13 from discharging through the switching element 9 during operation of the switch-mode power supply device 1, is connected in parallel with the output capacitor 13 and the inductor element 12. A feedback circuit 15 for monitoring the DC output voltage V₂ is connected to the controller 7. The feedback circuit 15 may for example be configured to signal to the controller 7 should the DC output voltage V₂ deviate by more than a predetermined value from a reference voltage. Excluding the feedback circuit 15 is a possible alternative.

The switch-mode power supply device 1 has an auxiliary circuit 16 which is configured to provide an auxiliary voltage V₃. The auxiliary voltage V₃ is typically a DC voltage having a constant magnitude or a substantially constant magnitude. The auxiliary voltage V₃ may for example be in the range from about 5 V to about 12 V. The auxiliary voltage V₃ is supplied to a load 17 via one or more auxiliary output terminals 23. The load 17 is connected to the ground potential 10, i.e. the same ground potential as the main circuit 6. In general, however, the load 17 does not have to be connected to the same ground potential as the main circuit 6. Example of typical loads 17 are control circuits, microprocessors, photoelectric sensors, passive infrared sensors or controllers for drivers for light-emitting diodes. The load 17 may be a component of the switch-mode power supply device 1. For example, the main circuit 6 may be connected to the auxiliary voltage V₃ so that the auxiliary voltage V₃ drives the controller 7. Alternatively, the load 17 is outside the switch-mode power supply device 1, i.e. the load 17 may form part of a circuit which is not included in the switch-mode power supply device 1.

The auxiliary circuit 16 has an auxiliary inductor 18 which is connected to receive the pulsed direct current generated by the switching element 9. The inductance of the auxiliary inductor 18 is usually much smaller than the inductance of the inductor element. According to some embodiments, the inductance of the auxiliary inductor 18 is in the range from about 10 μH to about 500 mH. The auxiliary inductor 18 and the inductor element 12 are magnetically isolated from each other, i.e. the auxiliary inductor 18 and the inductor element 12 are uncoupled. The auxiliary inductor 18 is connected to the ground potential 10 and the negative terminal 3b so that the auxiliary 16 and main 6 circuits are connected to a common ground potential. The auxiliary circuit 16 has a capacitor 19 connected to the ground potential 10. The auxiliary voltage V₃ is the voltage across the capacitor 19. The auxiliary circuit 16 also has a diode 20 connected to the auxiliary inductor 18 and the capacitor 19. The diode 20 may be a semiconductor diode. The auxiliary circuit 16 has a damping resistor 21 connected in parallel with the auxiliary inductor 18. A Zener diode 22 for limiting the auxiliary voltage V₃ is connected in parallel with the capacitor 19. Other embodiments of the auxiliary circuit 16 do not include the damping resistor 21 and/or the Zener diode 22.

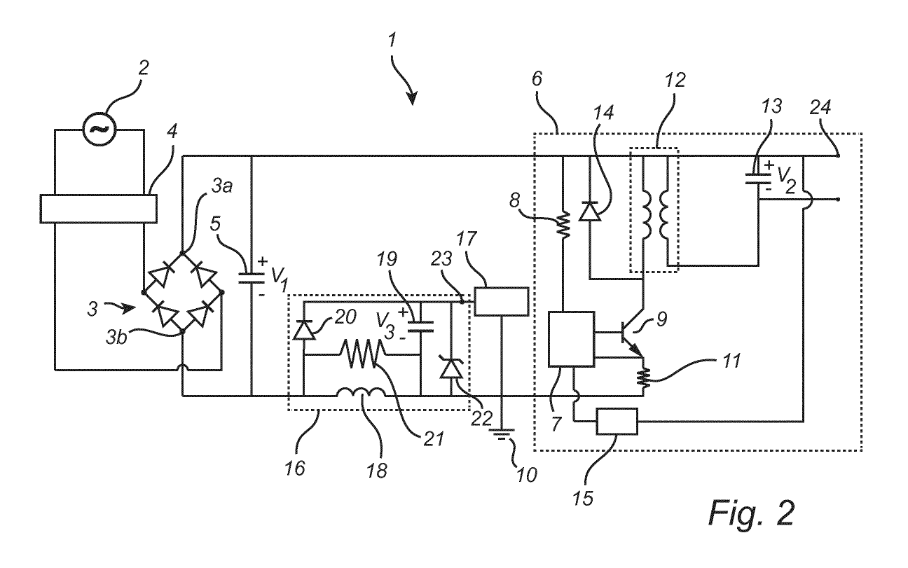

FIG. 2 illustrates a schematic circuit diagram of a switch-mode power supply device 1 which is similar to the switch-mode power supply device 1 in FIG. 1. In this example, however, the inductor element 12 is a transformer having two magnetically coupled coils of wire.

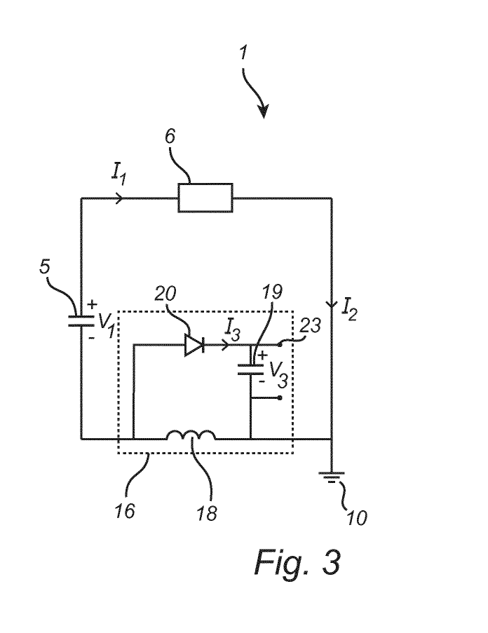

FIG. 3 is a schematic circuit diagram of a switch-mode power supply device 1 showing current flow indicated by arrows. During operation of the switch-mode power supply device 1, the DC input voltage V₁ applied across the input capacitor 5 results in an input current I₁ flowing from the positive polarity side of the input capacitor 5 into the main circuit 6, whereby the controller 7 starts to switch the switching element 9 between a conducting state and a non-conducting state. A start-up resistor 8 may help in the starting of the controller 7. The switching results in a pulsed direct current I₂ flowing from the switching element 9 to the ground potential 10 and to the auxiliary inductor 18. When the switching element 9 is in the conducting state, the auxiliary inductor 18 is charged by the pulsed direct current I₂. The switching of the switching element 9 to the non-conducting state results in a drop in the amplitude of the pulsed direct current I₂, whereby an induced current I₃ is generated. The induced current I₃ flows in the auxiliary circuit 16 trough the diode 20 to the capacitor 19 so that the capacitor 19 is charged. The amount of charge supplied to the capacitor 19 depends on the inductance of the auxiliary inductor 18, the strength of the output current I₂ and the switching frequency of the switching element 9. The diode 20 prevents the capacitor 19 from discharging as the switching element 9 is switched back to the conducting state. The switching process results in an auxiliary voltage V₃ being generated across the capacitor 19.

The person skilled in the art realizes that the present invention by no means is limited to the preferred embodiments described above. On the contrary, many modifications and variations are possible within the scope of the appended claims. For example, according to some embodiments, the main 6 and auxiliary circuits 16 are not connected to a common ground potential. The use of a level shifter may then be required.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A switch-mode power supply device comprising:
a main circuit configured to receive a DC input voltage and to provide a DC output voltage, the main circuit comprising:
an inductor element for providing the DC output voltage,
a switching element connected to the inductor element, and
a controller configured to switch the switching element between a conducting state and a non-conducting state, wherein the switching element is configured to feed a pulsed direct current to a ground potential; and
an auxiliary circuit configured to provide an auxiliary voltage, the auxiliary circuit comprising an auxiliary inductor,
the auxiliary inductor being connected to receive the pulsed direct current, and being magnetically isolated from the inductor element.

2. (canceled)

3. The switch-mode power supply device according to claim 1, wherein the auxiliary circuit further comprises
a capacitor connected to the ground potential, and
a diode connected to the auxiliary inductor and the capacitor,
wherein the auxiliary voltage is a voltage across the capacitor.

4. The switch-mode power supply device according to claim 3, wherein the auxiliary voltage is limited by a Zener diode connected in parallel with the capacitor 19.

5. The switch-mode power supply device according to claim 1, wherein the auxiliary circuit further comprises a damping resistor connected in parallel with the auxiliary inductor.

6. The switch-mode power supply device according to claim 1, wherein the inductor element is an inductor.

7. The switch-mode power supply device according to claim 1, wherein the inductor element is a transformer.

8. The switch-mode power supply device according to claim 1, wherein a start-up resistor is connected to the controller and a positive polarity of the DC input voltage.

9. The switch-mode power supply device according to claim 1, wherein the main circuit is connected to the auxiliary voltage.

10. The switch-mode power supply device according to claim 1, wherein the auxiliary voltage is configured to be connected to a load outside the switch-mode power supply device.
